(19) United States
(12) Patent Application Publication
(10) Pub. No.: US 2025/0055160 A1
(43) Pub. Date: Feb. 13, 2025

(54) POWER STORAGE DEVICE AND METHOD OF MANUFACTURING THE POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/611,713

(22) Filed: Mar. 21, 2024

(30) Foreign Application Priority Data
Aug. 7, 2023 (JP) 2023-128354

(51) Int. Cl. H01M 50/564; H01M 50/55; H01M 50/553

(52) U.S. Cl. CPC H01M 50/564; H01M 50/55; H01M 50/553

(57) ABSTRACT

A power storage device includes a current collecting terminal, a case member having a terminal insertion hole, and an insulating resin member connecting the current collecting terminal with a hole periphery and a hole surrounding portion of the terminal insertion hole. The current collecting terminal and the case member have seal portions that ensure airtightness in a case, at connecting portions connecting with the insulating resin member, and each of the seal portions is a roughened surface. The insulating resin member has a thermoplastic resin material including high molecular weight particles with a molecular weight of 10,000 or more and low molecular weight particles with a molecular weight of 500 to 5,000, and the low molecular weight particles are included 5 to 15% by weight in the thermoplastic resin material and are unevenly distributed closer to the roughened surface.

### CROSS-REFERENCE TO RELATED APPLICATIONS

This application is based upon and claims the benefit of priority to Japanese Patent Application No. 2023-128354 filed on Aug. 7, 2023, the entire contents of which are incorporated herein by reference.

### BACKGROUND

### Technical Field

The disclosed technology relates to a power storage device and a method of manufacturing the power storage device.

### Related Art

For example, Japanese unexamined patent application publication No. 2021-086813 (JP 2021-086813 A) discloses a sealed storage battery in which an insulating resin member is molded integrally with a current collecting terminal and a case member (insert molding) so as to fill space between the current collecting terminal and a terminal insertion hole of the case member. As described in the above-identified publication, roughened surfaces are formed on at least a part of contacting portions of the current collecting terminal and case member that contact the insulation resin member, so that the anchoring effect of the insulation resin member on the roughened uneven surfaces is enhanced. The insulating resin member is a resin material with heat resistance, formability, insulation, sealing property, and resistance to electrolytic solution, and PPS resin (polyphenylene sulfide resin) is one example of the resin material.

### SUMMARY

### Technical Problems

However, the insulating resin member such as the above PPS resin generally contains a large amount of high molecular weight particles with a molecular weight of 10,000 or more, and the high molecular weight particles have a large molecular size in the molten state and are less likely to penetrate into narrow gaps between projections on the roughened uneven surfaces. Therefore, during molding, the molten resin of the insulating resin member cannot sufficiently penetrate into the gaps on the roughened uneven surfaces, and the anchoring effect of the insulating resin member on the uneven surfaces cannot be enhanced. In addition, since the molten resin of the insulating resin member cannot sufficiently penetrate into the gaps on the roughened uneven surfaces, cavities are formed in the gaps on the uneven surfaces, and the sealing property of the insulating resin member at its contacting portions with the current collecting terminal and the case member deteriorates.

Also, since the insulating resin member comprised of the high molecular weight particles has a large molecular size in the molten state and is less likely to penetrate into narrow gaps on the roughened uneven surfaces during molding, it is necessary to force the molten resin to penetrate into the gaps on the uneven surfaces over time while keeping the pressure of and cooling the resin after injection of the molten resin into a cavity of a molding die is completed. Thus, it takes a long pressure keeping and cooling time, resulting in a reduction of the productivity.

The disclosed technology has been developed in view of the above problems. A first object to be achieved is to improve the anchoring effect and sealing property of an insulating resin member on roughened uneven surfaces, in a power storage device in which the roughened surfaces are formed at seal portions of connecting portions of a current collecting terminal and a case member connecting with the insulating resin member. A second object to be achieved is to shorten the pressure keeping and cooling time when the insulation resin member is molded integrally with the current collecting terminal and the case member (insert molding), to thereby improve the productivity.

### Means of Solving the Problems

(1) One aspect of the disclosed technology to achieve the above objects provides a power storage device including a current collecting terminal, a case member having a terminal insertion hole through which the current collecting terminal is inserted, and an insulating resin member that is molded with the current collecting terminal and the case member inserted, and is configured to connect a hole insertion portion of the current collecting terminal with a hole periphery and a hole surrounding portion of the terminal insertion hole. The current collecting terminal and the case member have seal portions that ensure airtightness in a case, at connecting portions that connect with the insulating resin member, and each of the seal portions is a roughened surface on which an uneven surface is formed. The insulating resin member has a thermoplastic resin material including high molecular weight particles with a molecular weight of 10,000 or more and low molecular weight particles with a molecular weight of 500 to 5,000, and the low molecular weight particles are included 5 to 15% by weight in the thermoplastic resin material and are unevenly distributed closer to the roughened surface.

(2) In the power storage device described above in (1), the uneven surface may be formed with an arithmetic mean roughness of 30 to 500 nm, and a resin surface layer adjacent to the uneven surface may have an increased amount of the low molecular weight particles with a molecular weight of 500 to 1,500, as compared with a resin internal layer remote from the uneven surface.

(3) A method of manufacturing the power storage device described above in (1) or (2) uses a molding die for injection molding the insulating resin member with the current collecting terminal and the case member inserted, and includes injecting the insulating resin member into gaps between projections on the uneven surface, before injection of the molten insulating resin member into a cavity of the molding die is completed.

### BRIEF DESCRIPTION OF THE DRAWINGS

FIG. 1 is an exploded perspective view of one form of a power storage device (an example) according to one embodiment;

FIG. 2 is a cross-sectional view taken along line A-A in FIG. 1;

FIG. 3 is an enlarged cross-sectional view of part B shown in FIG. 2;

FIG. 4 is an integral molecular weight distribution curve diagram showing the percentage of each molecular weight in the entire resin, in a thermoplastic resin material of an insulating resin member of this example shown in FIG. 3 and in a thermoplastic resin material of an insulating resin member of a comparative example;

FIG. 5 is a differential molecular weight distribution curve diagram showing the distribution state of each molecular weight in the thermoplastic resin material of the insulating resin member of this example shown in FIG. 3 and in the thermoplastic resin material of the insulating resin member of the comparative example;

FIG. 6 is a schematic cross-sectional view schematically illustrating the positional relationship between high molecular weight particles and low molecular weight particles in the thermoplastic resin material of the insulating resin member of this example shown in FIG. 4 and FIG. 5, at a resin surface layer of a roughened surface shown in FIG. 3;

FIG. 7 is a schematic cross-sectional view schematically illustrating the positional relationship between high molecular weight particles and low molecular weight particles in the thermoplastic resin material of the insulating resin member of the comparative example shown in FIG. 4 and FIG. 5, at the resin surface layer of the roughened surface shown in FIG. 3;

FIG. 8 is a cross-sectional view showing a molding die in a mold closed state, which is used in a method of manufacturing a power storage device according to another embodiment; and

FIG. 9 is a flowchart diagram of the method of manufacturing the power storage device using the molding die shown in FIG. 8.

### DETAILED DESCRIPTION OF THE EXEMPLARY EMBODIMENTS

### Description of Power Storage Device

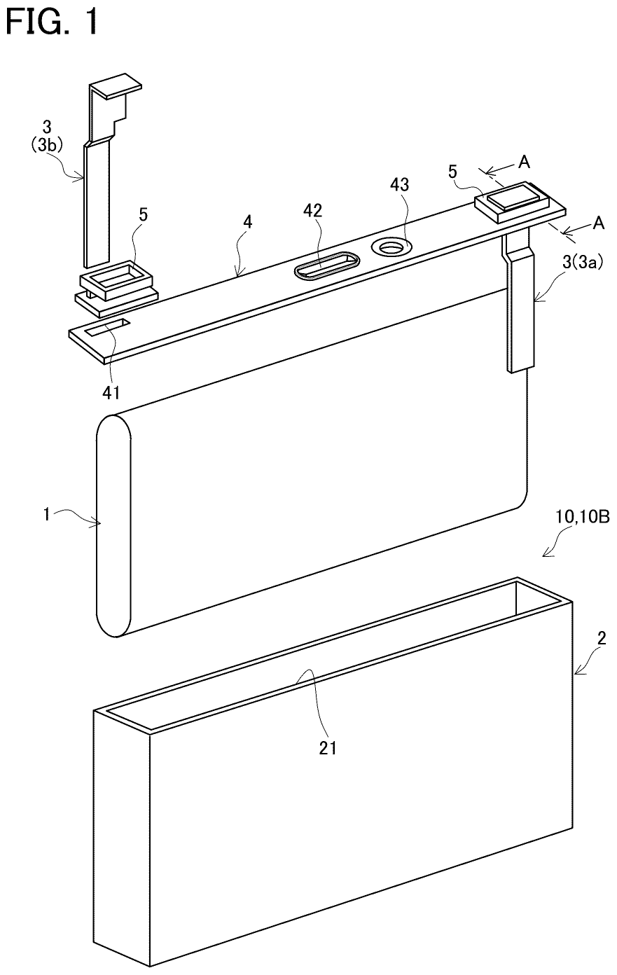

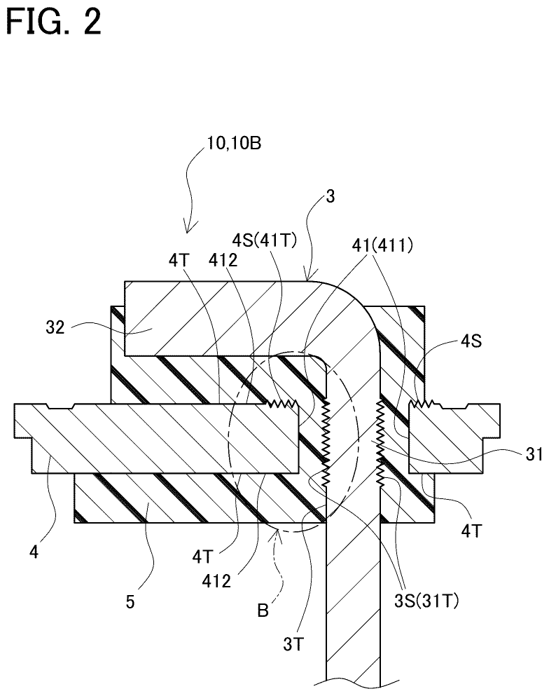

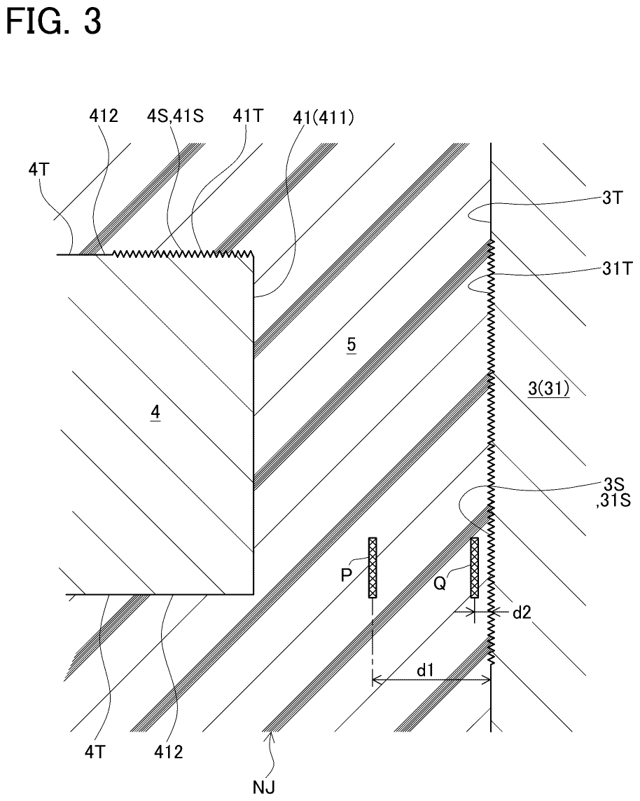

Next, one form of a power storage device 10 (an example) according to one embodiment of the above disclosed technology will be described in detail with reference to the drawings. FIG. 1 is an exploded perspective view of one form of the power storage device (this example) according to the embodiment. FIG. 2 is a cross-sectional view taken along line A-A shown in FIG. 1. FIG. 3 is an enlarged cross-sectional view of part B shown in FIG. 2.

As shown in FIG. 1 to FIG. 3, one form of the power storage device 10 (this example) according to the embodiment of the disclosed technology has current collecting terminals 3, a case member 4 having terminal insertion holes 41 through which the current collecting terminals 3 are inserted, and insulating resin members 5 each of which is molded with the corresponding current collecting terminal 3 and case member 4 inserted therein so as to connect a hole insertion portion 31 of the current collecting terminal 3 with a hole periphery 411 and a hole surrounding portion 412 of the terminal insertion hole 41.

The power storage device 10 includes an electrode body 1, a case body 2 having an opening 21 and housing the electrode body 1, current collecting terminals 3 electrically connected to the electrode body 1, and a case lid (corresponding to “case member”) 4 that holds the current collecting terminals 3 inserted through the terminal insertion holes 41 and the electrode body 1 via the current collecting terminals 3, and seals the opening 21 of the case body 2. The power storage device 10 also includes the insulating resin members 5 each of which is molded with the current collecting terminal 3 and case member 4 inserted therein so as to connect the hole insertion portion 31 of the current collecting terminal 3 with the hole periphery 411 and hole surrounding portion 412 of the terminal insertion hole 41. In this connection, the power storage device 10 is not necessarily limited to the above configuration. For example, the terminal insertion holes 41 may be formed in the case body 2.

Here, the power storage device 10 refers to general power storage devices from which electric energy can be retrieved, and includes, for example, primary batteries, secondary batteries, electric double layer capacitors, etc. The electrode body 1 is a known electrode body in which positive electrode bodies each having a positive active material layer and negative electrode bodies each having a negative active material layer are stacked via separators. The case body 2 is a rectangular tube-like body with a bottom and the opening 21 at the top end, and is made of aluminum or aluminum alloy, for example. The current collecting terminals 3 consist of a positive current collecting terminal 3a connected to the positive electrode side of the electrode body 1 and a negative current collecting terminal 3b connected to the negative electrode side. The positive current collecting terminal 3a is made of aluminum or aluminum alloy, for example, and the negative current collecting terminal 3b is made of copper or copper alloy, for example. The case lid (case member) 4 is made of, for example, aluminum or aluminum alloy and is formed as a lid like a flat plate. In the case lid (case member) 4 are formed the terminal insertion holes 41 through which the current collecting terminals 3 are inserted, a known safety valve 42, and a liquid inlet 43 through which an electrolytic solution is injected. The insulating resin member 5 has a thermoplastic resin material NJ with heat resistance, formability, insulation, sealing property, resistance to electrolytic solution, and so forth. Here, the thermoplastic resin material NJ is PPS resin (polyphenylene sulfide resin) but need not be limited to this. The insulating resin member 5 may contain a reinforcing member such as glass fibers, elastomer, etc. in the thermoplastic resin material NJ.

As shown in FIG. 3, the current collecting terminal 3 and the case member 4 have seal portions 31T, 41T that ensure airtightness in the case, at connecting portions 3T, 4T that connect with the insulating resin member 5. The seal portion 31T of the current collecting terminal 3 is formed like an encircling band around the entire circumference of the hole insertion portion 31, and the seal portion 41T of the case member 4 is formed at the hole surrounding portion 412 like an encircling band extending along the terminal insertion hole 41. The current collecting terminal 3 has an outside connecting portion 32 bent at right angles to the hole insertion portion 31, and one side of the outside connecting portion 32 closer to the case member 4 is connected to the insulating resin member 5. The seal portions 31T, 41T are roughened surfaces 3S, 4S where uneven surfaces 31S, 41S are formed, respectively. The uneven surfaces 31S, 41S are formed with an arithmetic mean roughness of, for example, 30 to 500 nm. “P” shown in FIG. 3 indicates a resin internal layer P (core layer) that is spaced from the connecting portion 3T, 4T by a separation distance d1 of 500 μm or more, and “Q” indicates a resin surface layer Q (skin layer) that is spaced from the connecting portion 3T, 4T by a separation distance d2 of about 10 to 20 μm. The uneven surfaces 31S, 41S with the arithmetic mean roughness of 30 to 500 nm can be formed, for example, by applying a pulsed laser beam traveling in a fixed direction to the surfaces of the connecting portions 3T, 4T, to diffuse fine atomized metal vapor, which is then deposited in a forest-like pattern and solidified.

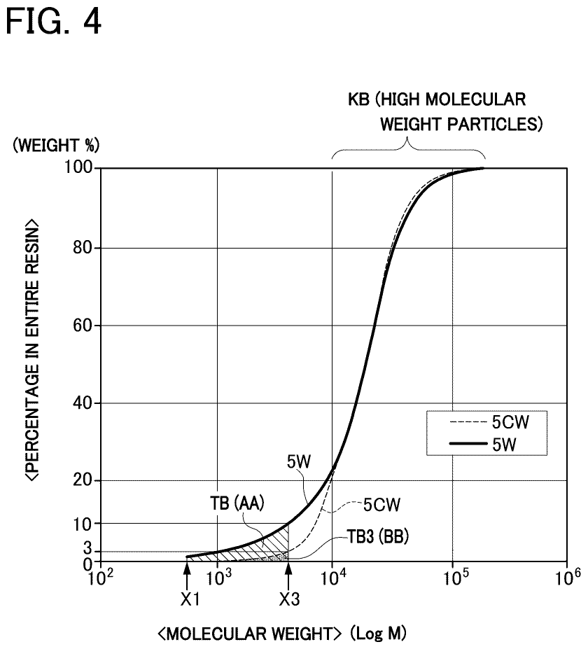

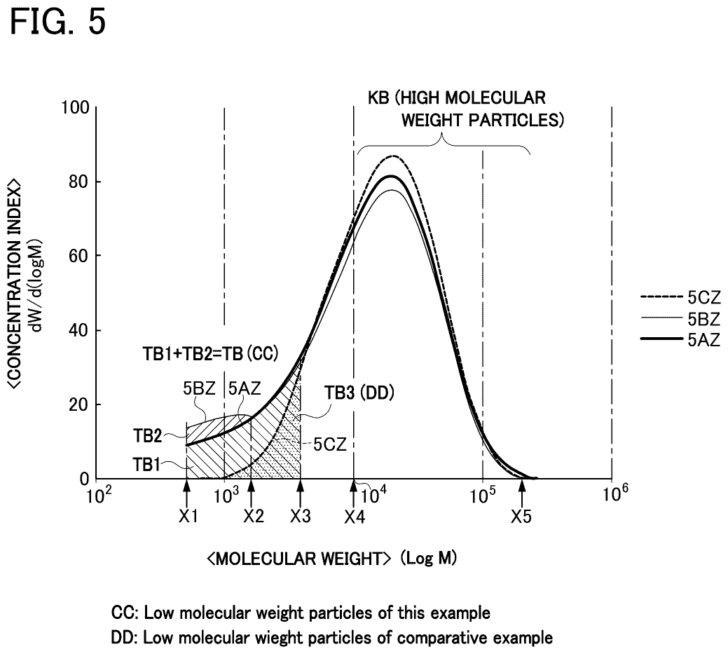

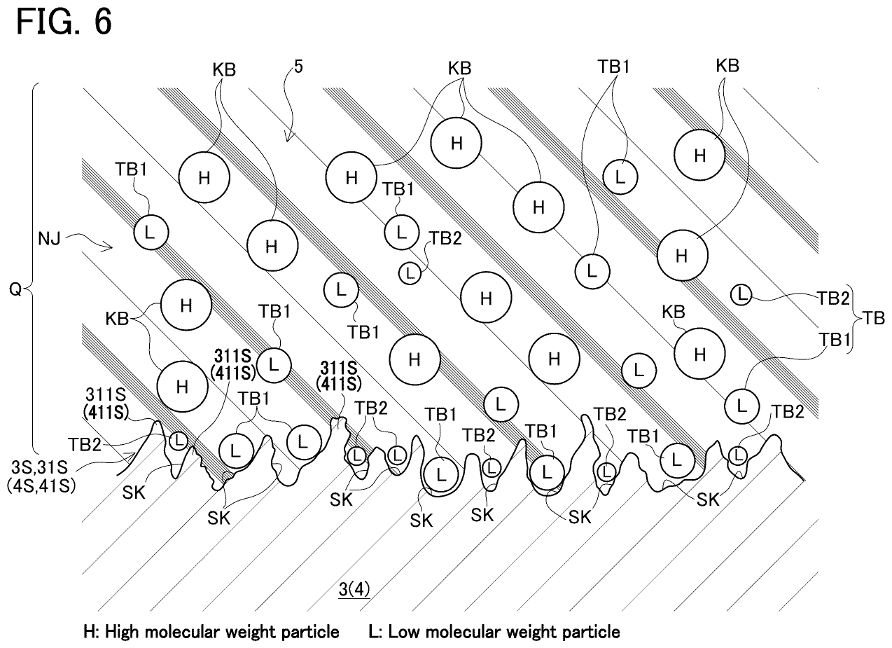

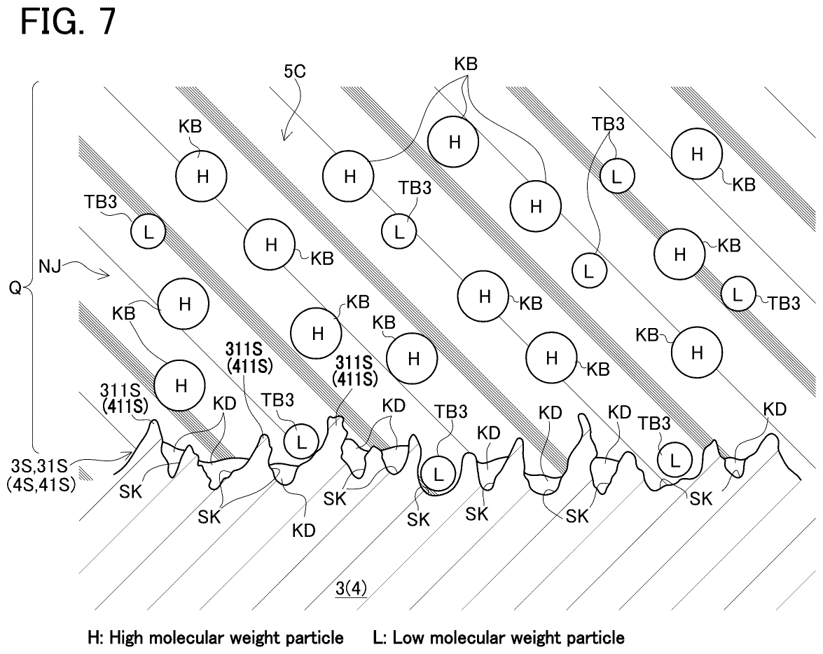

FIG. 4 is an integral molecular weight distribution curve diagram showing the percentage of each molecular weight in the entire resin, with respect to the thermoplastic resin material of the insulating resin member of this example shown in FIG. 3 and a thermoplastic resin material of an insulating resin member of a comparative example. FIG. 5 is a differential molecular weight distribution curve diagram showing the distribution state of each molecular weight in the thermoplastic resin material of the insulating resin member of this example shown in FIG. 3 and the thermoplastic resin material of the insulating resin member of the comparative example. FIG. 6 is a schematic cross-sectional view that schematically illustrates the positional relationship between high molecular weight particles and low molecular weight particles in the thermoplastic resin material of the insulating resin member of this example shown in FIG. 4 and FIG. 5 at the resin surface layer of the roughened surface shown in FIG. 3. FIG. 7 is a schematic cross-sectional view that schematically illustrates the positional relationship between high molecular weight particles and low molecular weight particles in the thermoplastic resin material of the insulating resin member of the comparative example shown in FIG. 4 and FIG. 5 at the resin surface layer of the roughened surface shown in FIG. 3.

The integral molecular weight distribution curve shown in FIG. 4 and the differential molecular weight distribution curve shown in FIG. 5 can be obtained according to the following procedure by the GPC (Gel Permeation Chromatography) method. First, a sample solution is prepared by dissolving a resin sample in a solvent solution. Then, the sample solution is passed through a column filled with a porous granular gel having fine pores, and the molecular size in the solution passed through the column is detected with a detector to obtain a chromatogram of the detected intensity of molecular size against detection time. Then, the detection time is converted to the molecular weight using a calibration curve obtained from a standard substance with a known relationship between the detection time and the molecular weight. The molecular weight (logarithmic value) is then plotted on the horizontal axis and the concentration fraction is plotted on the vertical axis. The integral molecular weight distribution curve shown in FIG. 4 is completed by sequentially adding up the plotted concentration fractions and plotting the molecular weight (logarithmic value) on the horizontal axis and the integrated value of the concentration fraction on the vertical axis. The “integrated value of the concentration fraction” corresponds to the “percentage in the entire resin”; therefore, the vertical axis in FIG. 4 is labeled with “Percentage (weight %) in the Entire Resin”.

Next, in the integral molecular weight distribution curve shown in FIG. 4, the slope (derivative value) of the curve at each molecular weight is obtained. The differential molecular weight distribution curve shown in FIG. 5 is completed by plotting the molecular weight (logarithmic value) on the horizontal axis and the derivative value on the vertical axis. Thus, the vertical axis of the differential molecular weight distribution curve is “dW/d(Log M)” (the value obtained by differentiating the concentration fraction with respect to the logarithmic value of the molecular weight), which is proportional to the “concentration fraction”; therefore, the vertical axis is labeled with “Concentration Index”. Specifically, a high-temperature GPC system (instrument No. GPC-H-2, PL-GPC220 manufactured by Polymer Laboratories), a detector (differential refractive index detector RI: Refractive Index Detector), a column (Shodex UT-G (guard column)), and solvent solution (1-chloronaphthalene produced by FUJIFILM Wako Pure Chemical Corporation) were used. The sample solution was passed through a 0.5 μm filter for filtering and 0.2 mL of the solution was then injected into the column heated to 210° C. at a flow rate of 0.7 mL/min. The integral molecular weight distribution curve shown in FIG. 4 and the differential molecular weight distribution curve shown in FIG. 5 can be automatically generated using an application software attached to the high-temperature GPC system (instrument No. GPC-H-2, PL-GPC220 manufactured by Polymer Laboratories).

The integral molecular weight distribution curve 5W shown in FIG. 4 represents the percentage of the molecular weight in the entire resin of the thermoplastic resin material NJ of the insulating resin member 5 in this example, and the integral molecular weight distribution curve 5CW represents the percentage of the molecular weight in the entire resin of the thermoplastic resin material NJ of the insulating resin member 5C in the comparative example. X1 on the horizontal axis indicates a molecular weight of 500, and X3 indicates a molecular weight of 5,000. The thermoplastic resin material NJ of the insulating resin member 5 in this example has about 10% by weight of low molecular weight particles TB with a molecular weight of 500 to 5,000 and about 77% by weight of high molecular weight particles KB with a molecular weight of 10,000 or more. In contrast, the thermoplastic resin material NJ of the insulating resin member 5C in the comparative example has about 3% by weight of low molecular weight particles TB3 with a molecular weight of 1,000 to 5,000 and about 78% by weight of high molecular weight particles KB with a molecular weight of 10,000 or more. Thus, the thermoplastic resin material NJ of the insulating resin member 5 in this example and the thermoplastic resin material NJ of the insulating resin member 5C in the comparative example have a common characteristic that they have a little less than 80% by weight of high molecular weight particles KB with a molecular weight of 10,000 or more, but the proportions of the low molecular weight particles TB and TB3 with a molecular weight of 5,000 or less in the entire resin are significantly different from each other. In addition, the thermoplastic resin material NJ of the insulating resin member 5 and the thermoplastic resin material NJ of the insulating resin member 5C are significantly different from each other in that low molecular weight particles with a molecular weight of 1,000 or less are included in the thermoplastic resin material NJ of the insulating resin member 5 in this example, but not included in the thermoplastic resin material NJ of the insulating resin member 5C in the comparative example.

Here, the low molecular weight particles TB with a molecular weight of 500 to 5,000 have a smaller molecular size in the molten state and higher fluidity and wettability in the molten state than the high molecular weight particles KB with a molecular weight of 10,000 or more; therefore, the low molecular weight particles TB are likely to collect on the roughened surfaces 3S, 4S during molding.

Accordingly, in the thermoplastic resin material NJ of the insulating resin member 5 in this example, as shown in FIG. 6, the low molecular weight particles TB with a molecular weight of 500 to 5,000 are released from the high molecular weight particles KB with a molecular weight of 10,000 or more during molding, as a result of fountain flow of the molten resin, and collect by a large amount in the resin surface layer Q (skin layer) adjacent to the roughened surface 3S, 4S, such that the low molecular weight particles TB can relatively easily penetrate into narrow gaps SK between the projections 311S, 411S on the roughened uneven surface 31S, 41S. As a result, the resin including the low molecular weight particles TB with a molecular weight of 500 to 5,000 fills the narrow gaps SK of the uneven surface 31S, 41S, and the anchoring effect of the insulating resin member 5 on the uneven surface 31S, 41S can be enhanced. Also, since the narrow gaps SK of the uneven surface 31S, 41S are filled with the resin including the above low molecular weight particles TB, cavities are less likely to be generated in the gaps SK, and the sealing property of the insulating resin member 5 is improved.

In contrast, the thermoplastic resin material NJ of the insulating resin member 5C in the comparative example has only about 3% by weight of low molecular weight particles TB3 with a molecular weight of 1,000 to 5,000. Thus, as shown in FIG. 7, even if the low molecular weight particles TB3 with a molecular weight of 1,000 to 5,000 are released from the high molecular weight particles KB with a molecular weight of 10,000 or more during molding as a result of the fountain flow of the molten resin, the low molecular weight particles TB3 collect only slightly in the resin surface layer (skin layer) Q adjacent to the roughened surface 3S, 4S, and do not easily penetrate into the narrow gaps SK between the projections 311S, 411S on the roughened uneven surface 31S, 41S. As a result, the low molecular weight particles TB3 with a molecular weight of 1,000 to 5,000 do not fill some of the narrow gaps SK of the uneven surface 31S, 41S, and the anchoring effect of the insulating resin member 5 on the uneven surface 31S, 41S is reduced. Also, since some of the narrow gaps SK of the uneven surface 31S, 41S are not filled with the above low molecular weight particles TB3, cavities KD are generated in the gaps SK, and the sealing property of the insulating resin member 5C is also reduced.

Meanwhile, if the low molecular weight particles TB with a molecular weight of 500 to 5,000 are excessively increased, for example, if the thermoplastic resin material NJ of the insulating resin member 5 includes about 20% by weight of low molecular weight particles TB in the entire resin material, the heat resistance and other properties deteriorate, making it difficult to maintain the characteristic values required for the power storage device 10. Thus, it is preferable that the content of the low molecular weight particles TB with a molecular weight of 500 to 5,000 does not exceed 15% by weight in the entire resin in the thermoplastic resin material NJ of the insulating resin member 5.

It has been found preferable from the above that, in the power storage device 10 of this example, the insulating resin member 5 has the thermoplastic resin material NJ including the high molecular weight particles KB with a molecular weight of 10,000 or more and the low molecular weight particles TB with a molecular weight of 500 to 5,000, and the low molecular weight particles TB are included 5 to 15% by weight in the thermoplastic resin material NJ and are unevenly distributed closer to the roughened surface 3S, 4S.

Next, the differential molecular weight distribution curve 5AZ shown in FIG. 5 represents the concentration index of the molecular weight of the thermoplastic resin material NJ in the resin internal layer P of the insulating resin member 5 in this example, and the differential molecular weight distribution curve 5BZ represents the concentration index of the molecular weight of the thermoplastic resin material NJ in the resin surface layer Q of the insulating resin member 5 in this example. The differential molecular weight distribution curve 5CZ represents the concentration index of the molecular weight of the thermoplastic resin material NJ in the resin surface layer Q of the insulating resin member 5C in the comparative example. X1 on the horizontal axis indicates a molecular weight of 500, X2 indicates a molecular weight of 1,500, X3 indicates a molecular weight of 5,000, X4 indicates a molecular weight of 10,000, and X5 indicates a molecular weight of 200,000.

As shown in FIG. 5, the thermoplastic resin material NJ of the insulating resin member 5 in this example and the thermoplastic resin material NJ of the insulating resin member 5C in the comparative example have a concentration index of about 35 for molecular weight 5,000, and there is generally no difference between them. However, the thermoplastic resin material NJ of the insulating resin member 5 in this example has a concentration index of about 15 for molecular weight 1,500, while the thermoplastic resin material NJ of the insulating resin member 5C in the comparative example has a concentration index of about 5 for molecular weight 1,500. Thus, there is a significant difference in the concentration index in the region equal to or lower than molecular weight 1,500. In particular, the thermoplastic resin material NJ of the insulating resin member 5 in this example has an increased amount of second low molecular weight particles TB2 with a molecular weight of 500 to 1,500 in the resin surface layer Q compared to the resin internal layer P, and the concentration index of the low molecular weight particles TB with a molecular weight of 500 to 1,500 is kept high at about 13 to 17. In contrast, in the thermoplastic resin material NJ of the insulating resin member 5C in the comparative example, even in the resin surface layer Q, the concentration index of the low molecular weight particles TB3 decreases from concentration index 3 for molecular weight 1,500 to concentration index 0 for molecular weight 1,000.

Accordingly, in the thermoplastic resin material NJ of the insulating resin member 5 in this example, as shown in FIG. 6, the second low molecular weight particles TB2 with a relatively small molecular weight of 500 to 1,500 collect by a large amount in the resin surface layer (skin layer) Q adjacent to the roughened surface 3S, 4S, such that they can easily penetrate into very narrow gaps SK between the projections 311S, 411S on the uneven surface 31S, 41S with an arithmetic mean roughness of 30 to 500 nm. As a result, the resin including the second low molecular weight particles TB2 with a molecular weight of 500 to 1,500 fills the narrow gaps SK of the uneven surface 31S, 41S, thus further enhancing the anchoring effect of the insulating resin member 5 on the uneven surface 31S, 41S. Also, since the narrow gaps SK of the uneven surface 31S, 41S are filled with the resin including the above second low molecular weight particles TB2, cavities are less likely to be generated in the gaps SK, and the sealing property of the insulating resin member 5 is further improved.

In contrast, in the thermoplastic resin material NJ of the insulating resin member 5C in the comparative example, even in the resin surface layer Q, the concentration index of the low molecular weight particles TB3 decreases from concentration index 3 for molecular weight 1,500 to concentration index 0 for molecular weight 1,000. Thus, as shown in FIG. 7, only a small amount of the resin including the low molecular weight particles TB3 with a molecular weight of 1,500 or less collects in the resin surface layer (skin layer) Q, and some of the narrow gaps SK between the projections 311S, 411S on the uneven surface 31S, 41S are not filled with the resin, resulting in a reduction of the anchoring effect of the insulating resin member 5 on the uneven surface 31S, 41S. Also, since some of the narrow gaps SK of the uneven surface 31S, 41S are not filled with the low molecular weight particles TB3, cavities KD are generated in the gaps SK, and the sealing property of the insulating resin member 5C is also reduced.

It has been found further preferable from the above that, in the power storage device 10B of this example, the uneven surface 31S, 41S of the roughened surface 3S, 4S is formed with an arithmetic mean roughness of 30 to 500 nm, and the amount of the second low molecular weight particles TB2 with a molecular weight of 500 to 1,500 is increased in the resin surface layer Q adjacent to the uneven surface 31S, 41S, as compared with the resin internal layer P remote from the uneven surface 31S, 41S. That is, it has been found more preferable that the low molecular weight particles TB include a larger amount of the second low molecular weight particles TB2 with a molecular weight of 500 to 1,500 in the resin surface layer Q adjacent to the uneven surface 31S, 41S, as compared with the first low molecular weight particles TB1 with a molecular weight of 500 to 5,000 in the resin internal layer P remote from the uneven surface 31S, 41S.

Thus, according to this embodiment, in the power storage device 10, 10B in which the roughened surfaces 3S, 4S are formed on the seal portions 31T, 41T of the connecting portions 3T, 4T connecting the current collecting terminal 3 and the case member 4 with the insulating resin member 5, the anchoring effect and sealing property of the insulating resin member 5 on the roughened uneven surfaces 31S, 41S can be enhanced.

### Description of Method of Manufacturing the Power Storage Device

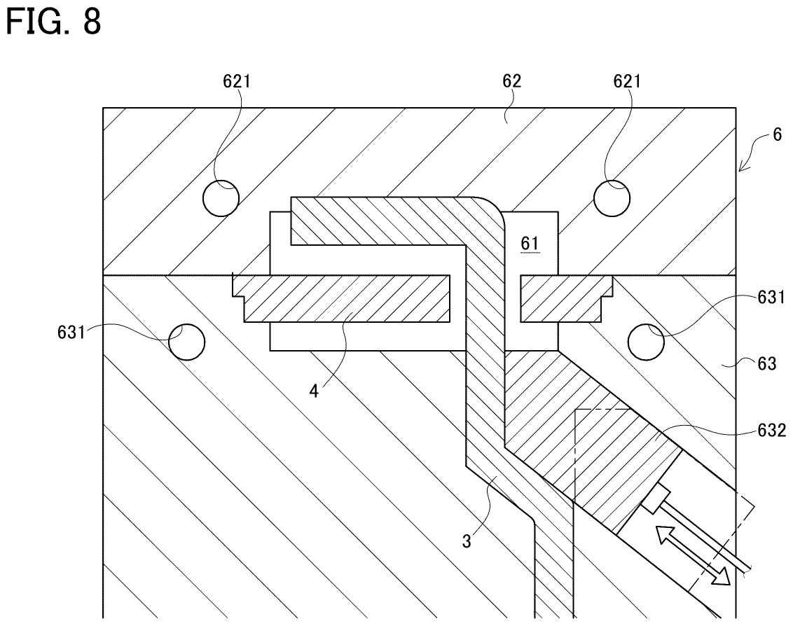

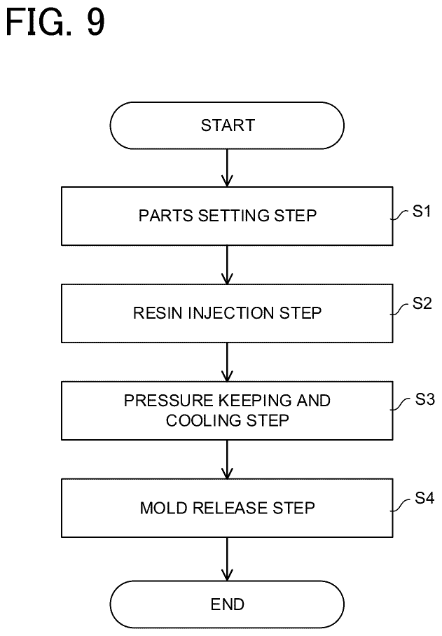

Next, a method of manufacturing the power storage device according to another embodiment of the disclosed technology will be described in detail with reference to the drawings. FIG. 8 is a cross-sectional view showing a molding die in a mold closed state, which die is used in the method of manufacturing the power storage device according to another embodiment. FIG. 9 is a flowchart diagram of the method of manufacturing the power storage device using the molding die shown in FIG. 8.

As shown in FIG. 8, and FIG. 9, the method of manufacturing the power storage device is the method of manufacturing the power storage devices 10, 10B described above, using a molding die 6 for injection molding the insulating resin member 5 with the current collecting terminal 3 and the case member 4 inserted therein. The method includes a resin injection step S2 for filling the gaps SK between the projections 311S, 411S on the uneven surfaces 31S, 41S with the insulating resin member 5 before the injection of the molten insulating resin member 5 into a cavity 61 of the molding die 6 is completed while the molding die 6 is in the mold closed state.

As shown in FIG. 8, the molding die 6 has a fixed die 62 and a movable die 63 where the cavity 61 is formed in which the insulating resin member 5 can be injection molded with the current collecting terminal 3 and case member 4 inserted therein while the molding die 6 is in the mold closed state. The fixed die 62 and the movable die 63 have pipes 621, 631, respectively, for heating and cooling the molding die 6. The movable die 63 is also provided with a slide die 632 that moves between an advanced position for pressing a bent portion of the current collecting terminal 3 and a retracted position that permits the current collecting terminal 3 to be inserted and removed.

As shown in FIG. 9, the method of manufacturing the power storage device 10, 10B includes a parts setting step S1 for setting the current collecting terminal 3 and the case member 4 in the molding die 6, the resin injection step S2 for injecting the molten insulating resin member 5 into the cavity 61 of the molding die 6, a pressure keeping and cooling step S3 for cooling the molten insulating resin member 5 to a temperature at which it can be released from the mold while applying an internal pressure to the insulating resin member 5, and a mold release step S4 for opening the mold to separate the movable die 63 from the fixed die 62 and removing the insert-molded insulating resin member 5, current collecting terminal 3, and case member 4 from the molding die 6.

This method of manufacturing the power storage device has the resin injection step S2 in which the gaps SK between the projections 311S, 411S on the uneven surfaces 31S, 41S are filled with the insulating resin member 5 before the injection of the molten insulating resin member 5 into the cavity 61 of the molding die 6 is completed. Therefore, when the insulating resin member 5 is molded integrally with the current collecting terminal 3 and the case member 4 (insert molding), there is no need to cause the molten resin of the insulating resin member 5 to penetrate into the gaps SK of the uneven surfaces 31S, 41S while keeping the pressure of and cooling the resin after the injection of the molten resin of the insulating resin member 5 into the cavity 61 of the molding die 6 is completed. Therefore, the time for pressure keeping and cooling after injection of the molten resin can be shortened, and the productivity can be improved. In addition, since the gaps SK of the uneven surfaces 31S, 41S are filled with the insulating resin member 5 before the injection of the molten resin into the cavity 61 of the molding die 6 is completed, the anchoring effect of the insulating resin member 5 on the uneven surfaces 31S, 41S can be enhanced and the sealing property of the insulating resin member 5 can be improved even if the pressure keeping and cooling time after the injection of the molten resin is reduced.

Thus, according to the method of manufacturing the power storage device, in the power storage device 10, 10B in which the roughened surfaces 3S, 4S are formed on the seal portions 31T, 41T of the connecting portions 3T, 4T of the current collecting terminal 3 and case member 4, which are connected to the insulating resin member 5, the anchoring effect of the insulating resin member 5 on the roughened uneven surfaces 31S, 41S and the sealing property of the insulating resin member 5 can be enhanced, and the pressure keeping and cooling time required when the insulating resin member 5 is molded integrally with the current collecting terminal 3 and case member 4 (insert molding) can be reduced, so that the productivity can be improved.

Each embodiment described above in detail is merely an example and does not limit the disclosed technology in any way. Thus, the disclosed technology can be subjected to various improvements and modifications without departing from its principle.

### REFERENCE SIGNS LIST

3 Current collecting terminal
3S, 4S Roughened surface
3T, 4T Connecting portion
4 Case member, Case lid
5 Insulating resin member
6 Molding die
10, 10B Power storage device
31 Hole insertion portion
31S, 41S Uneven surface
31T, 41T Seal portion
41 Terminal insertion hole
61 Cavity
311S, 411S projection
411 Hole periphery
412 Hole surrounding portion
KB High molecular weight particle
NJ Thermoplastic resin material
P Resin internal layer
Q Resin surface layer
S2 Resin injection step
SK Gap
TB, TB1, TB2 Low molecular weight particle

What is claimed is:

1. A power storage device comprising:
a current collecting terminal;
a case member having a terminal insertion hole through which the current collecting terminal is inserted; and
an insulating resin member that is molded with the current collecting terminal and the case member inserted, and is configured to connect a hole insertion portion of the current collecting terminal with a hole periphery and a hole surrounding portion of the terminal insertion hole,
wherein the current collecting terminal and the case member have seal portions that ensure airtightness in a case, at connecting portions that connect with the insulating resin member,
wherein each of the seal portions is a roughened surface on which an uneven surface is formed,
wherein the insulating resin member has a thermoplastic resin material including high molecular weight particles with a molecular weight of 10,000 or more and low molecular weight particles with a molecular weight of 500 to 5,000, and
wherein the low molecular weight particles are included 5 to 15% by weight in the thermoplastic resin material, and are unevenly distributed closer to the roughened surface.

2. The power storage device according to claim 1, wherein:
the uneven surface is formed with an arithmetic mean roughness of 30 to 500 nm; and
a resin surface layer adjacent to the uneven surface has an increased amount of the low molecular weight particles with a molecular weight of 500 to 1,500, as compared with a resin internal layer remote from the uneven surface.

3. A method of manufacturing the power storage device according to claim 1, using a molding die for injection molding the insulating resin member with the current collecting terminal and the case member inserted, the method including
injecting the insulating resin member into gaps between projections on the uneven surface, before injection of the molten insulating resin member into a cavity of the molding die is completed.

4. A method of manufacturing the power storage device according to claim 2, using a molding die for injection molding the insulating resin member with the current collecting terminal and the case member inserted, the method including
injecting the insulating resin member into gaps between projections on the uneven surface, before injection of the molten insulating resin member into a cavity of the molding die is completed.
